(19) United States
(12) Patent Application Publication
(10) Pub. No.: US 2018/0293568 A1
(43) Pub. Date: Oct. 11, 2018

(54) Electronic System and Method for Managing Usage of Merchant Facility Resources

(71) Applicant: MASTERCARD INTERNATIONAL INCORPORATED, PURCHASE, NY (US)

(72) Inventors: Arunmurthy Gurunathan, Pune (IN); Navneet Jain, Pune (IN)

(21) Appl. No.: 15/943,045

(22) Filed: Apr. 2, 2018

(30) Foreign Application Priority Data
Apr. 7, 2017 (SG) 10201702882W

(51) Int. Cl. G06Q 20/32; G06Q 20/42; G06Q 20/36

(52) U.S. Cl. CPC G06Q 20/325; G06F 1/163; G06Q 20/36; G06Q 20/42

(57) ABSTRACT

The present disclosure generally relates to an electronic system and method for managing usage of resources in a merchant facility. The system comprises a server and a merchant communication device, where the server is configured to receive, from the merchant communication device, identification details of a consumer from a wearable device during a first communication; communicate merchant data from the merchant communication device to the consumer wearable device upon receipt of the consumer identification details; receive, via the merchant communication device, resource usage data provided by the wearable device during a second communication; and receive a payment confirmation message upon transfer of an aggregated cost from a payment instrument of the consumer to the merchant financial account, wherein usage of the resources is tracked by the wearable device, and the aggregated cost is determined by the wearable device based on the tracked usage and rate details of the resources.

### CROSS-REFERENCE TO RELATED APPLICATION

This application claims the benefit of and priority to Singapore Patent Application No. 10201702882W filed Apr. 7, 2017. The entire disclosure of the above application is incorporated herein by reference.

### FIELD

The present disclosure generally relates to an electronic system and method for managing usage of merchant facility resources. More particularly, the present disclosure describes various embodiments of an electronic system, a method implemented in the system, as well as a device within the system for managing, e.g., assessing, charging, and paying for, usage of resources in a merchant facility, such as exercise/sports equipment in a fitness centre, or games in a recreational centre.

### BACKGROUND

This section provides background information related to the present disclosure which is not necessarily prior art.

Consumers patronize various merchant facilities to use their resources, e.g., services and amenities. A merchant facility may be a gym that provides resources such as gym equipment, e.g., weights and exercise machines, or may be a swimming complex that provides swimming pools for consumers to utilize. When consumers patronize a merchant facility, they are often required to pay an entry fee. The entry fee may be based on head count, i.e., each consumer pays a fixed fee or a variable fee according to age, or may be time-based, i.e., the amount of time spent in the merchant facility.

A problem with such forms of entry fees is that consumers do not spend the same amount of time in the same merchant facility. If the entry fees are charged on head count basis, a consumer who spends one hour at the merchant facility will be charged the same entry fee as another consumer who spends three hours at the merchant facility. The former consumer is in the loss as he/she doesn't get the satisfaction on the payment made for the entry fee. Even if both consumers spend the same amount of time in the merchant facility, they may make use of or consume the resources provided by the merchant facility differently. For example, a consumer may prefer to work out with free weights while another consumer may prefer to run on the treadmill. Both consumers may not feel satisfied with the amount paid as both will pay the same entry fee even though they consume different resources. Moreover, consumers do not spend every minute of their time in the gym exercising or utilizing the resources. They may take breaks for phone calls or simply to rest and relax. Some consumers may even need to leave the gym prematurely, such as to attend some other urgent matter. In these scenarios, consumers will not be satisfied in paying the full entry fee as they did not fully utilize their time spent in the gym.

Another problem with charging consumers a fee for every entry into the merchant facility is that consumers may feel inclined to spend more time in the merchant facility. Particularly, the consumers may feel that as they have paid for an entry into the merchant facility, they have the right to spend as much time as they want in the merchant facility, regardless of whether they are actually using the resources provided. This may lead to overcrowding in the merchant facility, prohibiting genuine consumers from patronizing the merchant facility, and thereby resulting in potential income loss for the merchant.

Therefore, in order to address or alleviate at least one of the aforementioned problems and/or disadvantages, there is a need to provide an electronic system and method for managing usage of resources in a merchant facility, in which there is at least one improved feature over the aforementioned prior art.

### SUMMARY

This section provides a general summary of the disclosure, and is not a comprehensive disclosure of its full scope or all of its features. Aspects and embodiments of the disclosure are set out in the accompanying claims.

According to a first aspect of the present disclosure, there is an electronic system, a method, and a non-transitory computer medium for managing usage of resources in a merchant facility. The system comprises a server and a merchant communication device, the server configured for performing steps of the method, comprising: receiving, from the merchant communication device, identification details of a consumer from a wearable device of the consumer during a first communication; communicating merchant data from the merchant communication device to the consumer wearable device upon receipt of the consumer identification details, the merchant data comprising rate details of the resources; receiving, via the merchant communication device, resource usage data provided by the consumer wearable device during a second communication, the resource usage data comprising an aggregated cost for the resources used by the consumer; and receiving a payment confirmation message upon transfer of the aggregated cost from a payment instrument of the consumer to a merchant financial account, wherein usage of the resources is tracked by the consumer wearable device, and the aggregated cost is determined by the consumer wearable device based on the tracked usage and rate details of the resources.

According to a second aspect of the present disclosure, there is a device wearable on a consumer, a method, and a non-transitory computer medium for managing usage of resources in a merchant facility. The consumer wearable device is linked to a digital wallet of the consumer and configured for performing steps of the method, comprising: communicating, to a merchant communication device of the merchant facility, identification details of the consumer during a first communication; receiving merchant data from the merchant communication device upon communication of the consumer identification details, the merchant data comprising rate details of the resources; communicating, to the merchant communication device, resource usage data during a second communication, the resource usage data comprising an aggregated cost for the resources used by the consumer; and transferring the aggregated cost from a payment instrument of the consumer to a merchant financial account, the payment instrument linked to the digital wallet, wherein usage of the resources is tracked by the consumer wearable device, and the aggregated cost is determined by the consumer wearable device based on the tracked usage and rate details of the resources.

An electronic system and method for managing usage of resources in a merchant facility according to the present disclosure is thus disclosed herein. Various features, aspects, and advantages of the present disclosure will become more apparent from the following detailed description of the embodiments of the present disclosure, by way of non-limiting examples only, along with the accompanying drawings.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an illustration of an electronic system for managing usage of resources in a merchant facility, in accordance with an embodiment of the present disclosure.

FIG. 2 is an illustration of a computerized method for managing usage of resources in a merchant facility, in accordance with an embodiment of the present disclosure.

FIG. 3 is a block diagram illustration of the technical architecture of a server of the electronic system of FIG. 1, in accordance with an embodiment of the present disclosure.

Corresponding reference numerals indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

In embodiments of the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “/” in a figure or associated text is understood to mean “and/or” unless otherwise indicated. The recitation of a particular numerical value or value range herein is understood to include or be a recitation of an approximate numerical value or value range.

For purposes of brevity and clarity, descriptions of embodiments of the present disclosure are directed to an electronic system and method for managing usage of resources in a merchant facility, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e., a skilled person, that the present disclosure may be practiced without specific details, and/or with multiple details arising from combinations of aspects of particular embodiments. In a number of instances, known systems, methods, procedures, and components have not been described in detail so as to not unnecessarily obscure aspects of the embodiments of the present disclosure.

The electronic system includes a server and a merchant communication device and is configured for performing a method for managing usage of resources in a merchant facility. When a consumer enters the merchant facility to use the resources inside, he/she uses a consumer wearable device to communicate with the merchant communication device, i.e., the consumer wearable device initiates a first communication with the merchant communication device. The consumer wearable device communicates identification details of the consumer to the merchant communication device during the first communication. The merchant communication device communicates merchant data to the consumer wearable device upon receipt of the consumer identification details. The merchant data includes rate details of the resources. The rate details are thus shared to the consumer such that the consumer can calculate the total cost or amount to pay the merchant for usage of the resources.

While the consumer is using the resources, the consumer wearable device tracks the usage of the resources, e.g., distance ran or time spent on a treadmill in a gym or fitness centre. The consumer wearable device determines resource usage data including an aggregated cost for the resources used by the consumer. The aggregated cost is determined by the consumer wearable device based on the tracked usage of the resources and the rate details of the resources.

After finishing using the resources, the consumer uses the consumer wearable device to communicate with the merchant communication device, i.e., the consumer wearable device initiates a second communication with the merchant communication device. The consumer wearable device communicates the resource usage data to the merchant communication device during the second communication. The resource usage data is thus shared to the merchant such that the merchant can subsequently tally the payment made by the consumer for the usage of the resources.

A payment transaction is initiated between the consumer and the merchant for paying the merchant with a payment instrument of the consumer. As the resource usage data and aggregated cost is determined by the consumer wearable device, the payable amount is determined on the consumer side instead of the merchant side. As a result of the payment transaction with the merchant, the aggregated cost is transferred from the payment instrument to a merchant financial account. Upon transfer of the aggregated cost from the payment instrument to the merchant financial account, the server receives a payment confirmation message and the consumer is permitted to exit the merchant facility.

Therefore, the consumer wearable device can track the consumer's usage of resources and calculate the aggregated cost, such that the consumer only pays the merchant based on the actual usage of the resources. This model of charging consumers by the merchant facility is advantageously fairer and more cost-effective to consumers and specific to each consumer's usage of the resources. Consumers can more effectively spend their time actively using the resources, collectively resulting in less time spent in the merchant facility for each consumer. The consumer turnaround time for the merchant facility is thus shorter, allowing more consumers to patronize the merchant facility and potentially resulting in higher income for the merchant.

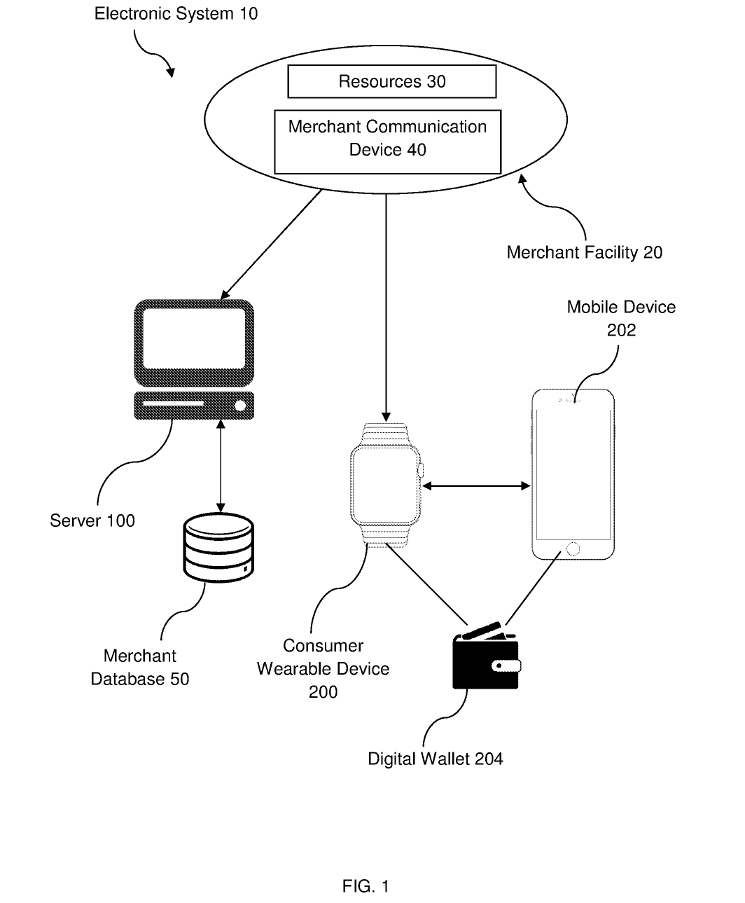

In representative or exemplary embodiments of the present disclosure, there is provided an electronic system 10 as illustrated in FIG. 1. The system 10 includes a host server or server 100 having a processor and a memory configured to store computer-readable instructions. The server 100 is operative within a merchant facility 20 or configured for operating the merchant facility 20, and specifically for performing a method for managing usage of resources 30 in the merchant facility 20. Managing the usage of the resources 30 may be, but is not limited to, assessing the costs of or fees for using the resources 30, charging the costs/fees by the merchant to the consumer, and paying for the costs/fees by the consumer.

The merchant facility 20 may be, but is not limited to, a gym, fitness centre, swimming complex, or recreational centre. Depending on the type of merchant facilities 20, the resources 30 provided by the merchant facilities 20 may range from weights and exercise machines in gyms to pool lanes in swimming complexes to games in a recreational centre, e.g., bowling alleys or billiard halls. The merchant facility 20 includes a merchant communication device 40 that is located on the premises of the merchant facility 20, and preferably near the entrance/exit areas thereof. The merchant communication device 40 is an electronic device that is communicatively linked to the server 100, and is configured for controlling access into and out of the merchant facility 20. The merchant communication device 40 may additionally be communicatively linked to a gateway for consumers to enter and exit the merchant facility 20. The gateway may be a form of physical entry gate, e.g., gantries, baffle gates, or turnstiles, which are controlled by the merchant communication device 40 and the server 100.

The system 10 includes a wearable device 200 of a consumer who is patronizing or visiting the merchant facility 20 to consume/use/utilize the resources 30. The consumer wearable device 200 is configured to be communicable with the merchant communication device 40 and consequently the server 100 in order to gain entry into the merchant facility 20. The consumer wearable device 200 is a mobile electronic device that is wearable on the body of the consumer, such as smartwatches on the wrists. In one embodiment, the consumer wearable device 200 is a standalone electronic device for performing various steps of the method 300 (as described below) for managing usage of resources 30 in the merchant facility 20. In another embodiment, the consumer wearable device 200 is paired and communicative with another mobile device 202 that is carried by or placed near the consumer. The mobile device 202 may be a mobile phone, smartphone, personal digital assistant (PDA), tablet, laptop, or computer. In this embodiment, the consumer wearable device 200 may be an exercise/sports tracking device, e.g., Fitbit® tracker, which is communicative with the mobile device 202. The consumer wearable device 200 and mobile device 202 cooperate together to perform various steps of the method 300 for managing usage of resources 30 in the merchant facility 20. Communications between the consumer wearable device 200 and mobile device 202 may occur wirelessly, such as via Bluetooth communication protocols, as will be readily understood by the skilled person.

The consumer wearable device 200 is communicatively linked to a digital wallet 204 which allows the consumer to pay for the consumption/usage/utilization of the resources 30 in the merchant facility 20. In one embodiment, the consumer wearable device 200 is operative to function as the digital wallet 204 by executing a digital wallet application, such as Apple Pay®, Samsung Pay®, or MasterPass®. In another embodiment, the consumer wearable device 200 is communicatively linked to the mobile device 202 which is operative to function as the digital wallet 204, again by executing a digital wallet application. One or more payment instruments, e.g., payment cards, of the consumer are linked to the digital wallet 204 such that payments to a merchant operating the merchant facility 20 are made from the linked payment instruments. The term “payment card” may refer to a credit card, debit card, prepaid card, or charge card, which the consumer may use to pay for transactions. The term “payment instrument” may refer to any suitable cashless payment mechanism. In addition to payment cards, payment instruments may include, but are not limited to, membership cards, promotional cards, frequent flyer cards, identification cards, gift cards, and/or any other payment cards that may hold payment card information and which may be stored electronically. It will be appreciated that the digital wallet 204 may alternatively be configured to receive pre-paid funds or be recharged/reloaded with funds (e.g., from a financial or bank account of the consumer). In this way, the consumer may select an amount to pay or add into the digital wallet 204.

The digital wallet 204 can be hosted remotely on a computing system or cloud, wherein the digital wallet 204 can be accessed by the consumer by a digital wallet application, software application, website, or any user interface (collectively referred to as “application”) using the consumer wearable device 200/mobile device 202. The consumer wearable device 200/mobile device 202 is thus linked to the digital wallet 204 and the application enables the consumer to operate and control the digital wallet 204 therewith, including making payments for consumption of the resources 30 at the merchant facility 20.

The system 10 further includes a merchant database 50 communicatively linked to the server 100 for retrieval of data therefrom. The merchant database 50 stores merchant data, such as details representing a financial account of the merchant and rate or tariff details of the resources 30. The merchant financial account details, such as an account identifier or number, provide information associated with the merchant financial account for performing financial transactions, e.g., for receiving payments or initiating payment request transactions. The rate details set out the prices for consumption or usage of the resources 30 with reference to some basis. For example, the rate for consuming a treadmill in a gym, i.e., running on the treadmill, is $10 per hour, and the rate for swimming in a swimming complex is $20 per hour. It will be appreciated that the rate details for various resources 30 in various merchant facilities 20 are determined by the merchants. Furthermore, the basis for the rate details may vary, such as being based on count (i.e., number of times a resource 30 is used) or distance covered on the treadmill/swimming pool, e.g., $1 per kilometre on the treadmill, instead of time spent or duration. The merchant database 50 may reside on the server 100, or alternatively on a remote server or computer communicatively linked to the server 100.

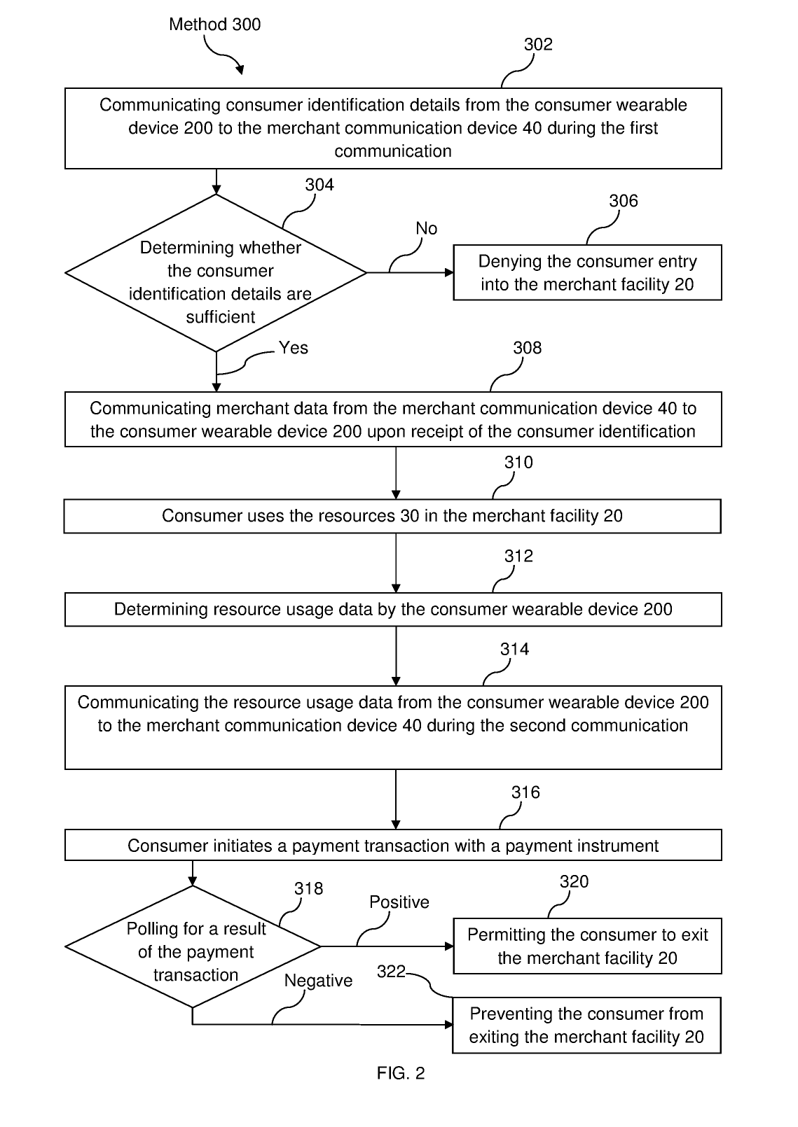

With reference to FIG. 2, there is shown a computer-implemented or computerized method 300, i.e., implemented on a computer or computer system, such as the electronic system 10, for managing usage of resources 30 in a merchant facility 20. Various steps of the method 300 are performed by various elements of the electronic system 10, including the merchant communication device 40, server 100, and consumer wearable device 200.

In various embodiments, a consumer patronizes a merchant facility 20, e.g., gym or fitness centre, to consume or use the resources 30 inside, e.g., weights, exercise machines, treadmills, etc. In some situations, the gym or fitness centre may include a swimming pool as one of its resources 30 for the consumer to use. The merchant communication device 40 is preferably located near the entrance/exit areas of the merchant facility 20. When the consumer enters the merchant facility 20, he/she uses the consumer wearable device 200 to communicate with the merchant communication device 40, i.e., the consumer wearable device 200 initiates a first communication with the merchant communication device 40. The first communication represents an entry of the consumer into the merchant facility 20 and begins a session for the consumer at the merchant facility 20, wherein the consumer can use the resources 30 at the merchant facility 20 during this session.

In step 302 of the method 300, the consumer wearable device 200 communicates identification details of the consumer to the merchant communication device 40 during the first communication with the merchant communication device 40. In one embodiment, the consumer identification details are stored on the merchant communication device 40. In another embodiment, the consumer identification details are communicated from the consumer wearable device 200 to the server 100 via the merchant communication device 40 and stored on the server 100. The consumer identification details may include personal information of the consumer, e.g., name, age, and address, etc. The consumer identification details may additionally include identification data of the consumer wearable device 200/mobile device 202, e.g., media access control (MAC) addresses thereof. In one embodiment, the consumer identification details are pre-stored on the consumer wearable device 200, e.g., on a database therein. In another embodiment, the consumer identification details are pre-stored on the mobile device 202 and retrieved by the consumer wearable device 200 before communicating to the merchant communication device 40.

In some embodiments, the consumer identification details are communicated from the consumer wearable device 200 to the merchant communication device 40 when the consumer wearable device 200 is located in the vicinity of the merchant communication device 40, such as when the consumer taps or waves the consumer wearable device 200 near the merchant communication device 40. The consumer identification details may be communicated in the form of near field communications (NFC) data or other forms of contactless/wireless communication data) or a matrix barcode, as desired by the consumer depending on the configuration of the consumer wearable device 200. In one embodiment, the communication between the consumer wearable device 200 and merchant communication device 40 occurs via a wireless communication protocol, e.g., NFC, Bluetooth low energy (BLE), or Wi-Fi. The consumer wearable device 200 is thus NFC-enabled and includes an NFC component, and the merchant communication device 40 is likewise NFC-enabled and includes an NFC component. In another embodiment, the consumer identification details may be embedded as a QR code displayed on the consumer wearable device 200. The merchant communication device 40 may include an optical scanner to visually scan the QR code from a display screen of the consumer wearable device 200.

In some other embodiments, the consumer wearable device 200 has to be physically connected or engaged to the merchant communication device 40 for communication therebetween. The consumer wearable device 200 includes an input port for connection/engagement with a connector of the merchant communication device 40, thereby initiating a wired communication therebetween. The input port and connector may operate by known wired communication protocols, such as Universal Serial Bus (USB).

Optionally, in step 304 of the method 300, the server 100 determines whether the consumer identification details received in step 302 are sufficient for the consumer to gain access or entry into the merchant facility 20. Specifically, the server 100 assesses the completeness and prima facie authenticity of the consumer identification details, i.e., whether the consumer identification details are complete, i.e., all prerequisite personal information is obtained, and at least appear authentic. The server 100 may be linked to a consumer database recording details of consumers who have visited the merchant facility 20 before, particularly for membership-only types of merchant facilities 20. The server 100 may verify the consumer identification details against the consumer database before allowing the consumer to enter the merchant facility 20. If the consumer identification details are determined to be insufficient, step 304 proceeds to step 306 of denying the consumer entry into the merchant facility 20. Conversely, if the consumer identification details are determined to be sufficient, step 304 proceeds to step 308.

In step 308, the merchant communication device 40 communicates merchant data to the consumer wearable device 200 upon receipt of the consumer identification details in step 302. The merchant data is retrievable from the merchant database 50 and communicated from the server 100 to the consumer wearable device 200 via the merchant communication device 40. The merchant data includes rate details of the resources 30 available in the merchant facility 20. Optionally, the merchant data includes the merchant financial account details, such as account identifier or number. In one embodiment, the merchant data is stored on the consumer wearable device 200. In another embodiment, the merchant data is communicated from the consumer wearable device 200 to the mobile device 202 and stored thereon. The rate details is thus shared to the consumer such that the consumer can calculate the total cost or amount to pay the merchant for usage of the resources 30 during the session in the merchant facility 20.

In step 310 of the method 300, the consumer uses the resources 30 in the merchant facility 20. In step 312, the consumer wearable device 200 tracks the usage of the resources 30 by the consumer. Specifically, the consumer wearable device 200 determines the usage of the resources 30 based on at least one of count, duration, and distance. In one example, the merchant facility 20 is a gym or fitness centre and one of the resources 30 is a treadmill. The consumer wearable device 200 may track the usage of the treadmill based on the number of times the treadmill is used or operated, the time spent on using the treadmill, and/or the distance covered (e.g., jogging or running) on the treadmill. In another example, there is another resource 30 which is a swimming pool. The consumer wearable device 300 may track the usage of the swimming pool based on number of times the consumer dives or enters the swimming pool, the time spent inside the swimming pool, and/or the distance covered (e.g., swimming or aqua-jogging) in the swimming pool.

In one embodiment, the consumer wearable device 200 tracks the usage of the resources 30 based on duration, i.e., time spent on each resource 30, and the rate details of the resources 30 are correspondingly based on time. More specifically, the consumer wearable device 200 tracks active usage of the resources 30, i.e., a resource 30 is considered to be used if the consumer is actively using it, instead of, for example, merely idling around the resource 30. For example, continuous jogging/running on a treadmill is considered as active use and will be recorded as usage of the treadmill. However, if the consumer is just standing beside the treadmill or is stationary on the treadmill, e.g., pausing to rest or take a phone call, there is no active use of the treadmill and no usage is recorded. The consumer wearable device 200 may be configured to notify the consumer, e.g., by an alarm, if the consumer wearable device 200 detects that the rest/idle time is beyond a predefined time period. The alarm may persuade the consumer to stop resting/idling and to continue active usage of the resources 30. The alarm may also inform the consumer that there could be a malfunction in the tracking of the resource usage, particularly when the consumer is actively using a resource 30 and the alarm is still activated. Furthermore, the merchant facility 20 may charge a nominal rate for rest/idle time or non-active time spent in the merchant facility 20, such as $1 per hour. This may be helpful in deterring consumers from wasting time at the merchant facility 20, contributing to the crowd and new consumers may be reluctant from patronizing the crowded merchant facility 20. It will be appreciated that similar considerations can be extended to other resources 30, such as swimming pool in the gym/fitness centre, as well as various resources 30 in various merchant facilities 20.

The consumer wearable device 200 includes various components to assist in the tracking of usage of the resources 30. These components include, but are not limited to, timers, gyroscopes, accelerometers, altimeters, pedometers, geolocation modules, etc. Usage of the resources 30 may be tracked by the consumer wearable device 200 based on anatomical movements of the consumer at each resource 30. Specifically, the consumer wearable device 200 tracks the movements of the consumer's limbs and other body parts to determine the type of exercise or activity the consumer is doing, e.g., running or swimming, and consequently the resource 30 the consumer is using, e.g., treadmill or swimming pool. For example, if the consumer is actively using the treadmill and running on it, the consumer wearable device 200 can track the movements of the arms, hips, and legs to determine the consumer's gait and whether the consumer is running. As running gaits are notably different from walking gaits, the consumer wearable device 200 will be able to differentiate running on the treadmill from walking inside the merchant facility 20, e.g., between resources 30. In another example, if the consumer is actively swimming in the swimming pool, the consumer wearable device 200 can track the anatomical movements and determine whether the consumer is swimming. The consumer wearable device 200 may additionally track the swimming strokes and determine the swimming style which the consumer is adopting.

The anatomical movements of the consumer may be tracked by the consumer wearable device 200 and compared against a data collection from a larger population. Particularly, if the tracked anatomical movements of the consumer are similar to certain anatomical movements in the data collection and a specific exercise/activity is associated therewith, the consumer wearable device 200 will be able to determine that the consumer is doing the same exercise/activity. As an example, the consumer wearable device 200 may be a Fitbit® device with a SmartTrack™ feature that is able to automatically recognize exercises or continuous, high-movement activities, such as walking, running, biking, elliptical, and swimming.

Usage of the resources 30 may also be tracked by the consumer wearable device 200 based on proximity of the consumer wearable device 200 to each resource 30. The resources 30 include sensors located therein for identifying the location of the resources 30 within the merchant facility 20. The sensors may be beacon devices that operate on Wi-Fi or Bluetooth communications protocols. The proximity of the consumer wearable device 200 to each resource 30 is determined based on communication between the consumer wearable device 200 and the sensors located at the resources 30. For example, if the consumer is using the treadmill, there is a sensor at the treadmill which will detect and communicate with the consumer wearable device 200 when they are within transmission range of each other. The detection of the sensor by the consumer wearable device 200 provides an additional confirmation that the consumer is at the treadmill and potentially using it. Alterative, or in addition, to sensors at the resources 30, the proximity of the consumer wearable device 200 to each resource 30 may be determined based on the position of the consumer wearable device 200 within the merchant facility 20. More specifically, the position of the consumer wearable device 200 can be detected by a geolocation module with reference to a digital map or layout of the merchant facility 20.

During usage of the resources 30 in step 310, the consumer wearable device 200, in step 312, determines resource usage data including an aggregated cost for the resources 30 used by the consumer during the session. Specifically, the aggregated cost is determined by the consumer wearable device 200 based on the tracked usage of the resources 30 and the rate details of the resources 30.

In one embodiment, the consumer spends 70 minutes during the session in the merchant facility 20, e.g., gym or fitness centre. During this 70-minute session, the consumer spends 20 minutes using a treadmill and 40 minutes using a swimming pool in the gym/fitness centre. The consumer spends the remaining 10 minutes not actively using any of the resources 30 in the merchant facility 20, i.e., the remaining 10 minutes is spent resting or idling or walking between the treadmill and swimming pool. The rate details provided by the merchant facility 20 (in step 308) indicate that usage of the treadmill costs $10 per hour and usage of the swimming pool costs $20 per hour. Thus, the cost for using the treadmill is $3.33 and the cost for using the swimming pool is $13.33. The aggregated cost for the resources 30 used by the consumer during the session in the merchant facility 20 is $16.66.

In another embodiment, during the session in the gym or fitness centre, the consumer runs 5 kilometres on the treadmill and swims 500 metres in the swimming pool. The rate details provided by the merchant facility 20 (in step 308) indicate that usage of the treadmill costs $1 per kilometre and usage of the swimming pool costs $20 per kilometre. Thus, the cost for using the treadmill is $5 and the cost for using the swimming pool is $10. The aggregated cost for the resources 30 used by the consumer during the session in the merchant facility 20 is $15.

In yet another embodiment, during the session in the gym or fitness centre, the consumer uses only a lats (latissimus dorsi muscle) pulldown machine. The rate details provided by the merchant facility 20 (in step 308) indicate that usage of the lats pulldown machine costs $2 per 100 repetitions or counts. If the consumer does 50 repetitions, the cost for using the lats pulldown machine will be $1.

At the end of the session after finishing using the resources 30, the consumer approaches the exit area of the merchant facility 20 where the merchant communication device 40 is preferably located. The consumer uses the consumer wearable device 200 to communicate with the merchant communication device 40, i.e., the consumer wearable device 200 initiates a second communication with the merchant communication device 40. The second communication represents an exit of the consumer from the merchant facility 20 and ends the session for the consumer at the merchant facility 20.

In step 314 of the method 300, the consumer wearable device 200 communicates the resource usage data to the merchant communication device 40 during the second communication with the merchant communication device 40. In one embodiment, the resource usage data is stored on the merchant communication device 40. In another embodiment, the resource usage data is communicated from the consumer wearable device 200 to the server 100 via the merchant communication device 40 and stored on the server 100. The resource usage data includes the aggregated or combined cost for the resources 30 used by the consumer during the session. The resource usage data is thus shared to the merchant such that the merchant can subsequently tally the payment made by the consumer for the usage of the resources 30.

In step 316 of the method 300, the consumer initiates a payment transaction with a payment instrument of the consumer or the digital wallet 204 linked to the consumer wearable device 200/mobile device 202. The consumer's payment instrument may be linked to the digital wallet 204. As the resource usage data and aggregated cost is determined by the consumer wearable device 200, the consumer is aware of how the resources 30 are used by him/her and the final amount to pay the merchant for the usage. As such, the payable amount is determined on the consumer side instead of the merchant side. The consumer thus initiates the payment transaction in step 316 for transferring the aggregated cost from the payment instrument to the merchant financial account.

In one example, the merchant data (in step 308) does not include the merchant financial account details and thus such information is not shared to the consumer. In step 316, the consumer wearable device 200/mobile device 202 communicates details of the consumer payment instrument (e.g., credit card identifier or number) to the merchant. The payment instrument details may be communicated to the merchant communication device 40. Alternatively, the payment instrument details may be communicated to the merchant via an application, e.g., browser, running on the consumer wearable device 200/mobile device 202. Yet alternatively, the consumer may activate the digital wallet 204, which the payment instrument is linked to, and communicate the payment instrument details to the merchant. As the merchant has the resource usage data and the payment instrument details, the merchant can proceed with the payment transaction for requesting payment of the aggregated cost from the consumer's payment instrument. The merchant communicates with a payment network (e.g., credit card network or Automated Clearing House (ACH) network) that performs the payment transaction. Specifically, the payment network communicates data on the payment instrument details and aggregated cost to the issuer bank of the payment instrument (e.g., credit card). The issuer bank then approves or declines the payment request and communicates the result back to the payment network. If the payment request is approved, the approval is communicated from the payment network to the acquirer bank of the merchant financial account. This payment transaction may otherwise be referred to as a “pull payment” which operates in a similar manner as a standard electronic commerce transaction.

In another example, the merchant data (in step 308) includes the merchant financial account details and thus such information is shared to the consumer. In step 316, the consumer initiates the payment transaction on the consumer wearable device 200/mobile device 202. The payment transaction may be initiated with an application, e.g., browser, running on the consumer wearable device 200/mobile device 202. Alternatively, the payment transaction may be initiated with the digital wallet 204, which the payment instrument is linked to. As the consumer has the merchant financial account details, the consumer can proceed with the payment transaction for paying the aggregated cost from the consumer's payment instrument to the merchant financial account. The consumer wearable device 200/mobile device 202 communicates with the payment network that performs the payment transaction in a similar manner as described in the previous example. Alternatively, the payment instrument is a bank account of the consumer and the payment from the consumer to the merchant may be a standard bank-to-bank payment (from the consumer bank account to the merchant financial account). This payment transaction may otherwise be referred to as a “push payment”. As the merchant also has the resource usage data (in step 314), the merchant can tally the payment made by the consumer in this payment transaction.

In step 318 of the method 300, the server 100 polls for a result of the payment transaction, specifically whether the aggregated cost has been transferred to the merchant financial account. In one embodiment, the merchant communication device 40 is connected to a gateway for preventing the consumer from exiting the merchant facility 20 before the aggregated cost is transferred to the merchant financial account. Upon transfer of the aggregated cost from the consumer's payment instrument to the merchant financial account, a payment confirmation message indicating the positive result is communicated the server 100, e.g., from the bank of the merchant financial account. Additionally, the server 100 may tally the payment amount received in the merchant financial account with the resource usage data obtained from the consumer wearable device 200 in step 314. Step 318 then proceeds to step 320 in which the gateway opens and the consumer is permitted to exit the merchant facility 20. The merchant communication device 40 or an alert device connected thereto may indicate a green light and/or sound an audio signal in step 320 to notify working staff in the merchant facility 20.

Conversely, if the aggregated cost has not been received in the merchant financial account, a payment declined message indicating the negative result is communicated to the server 100. Alternatively, the server 100 does not receive any payment message, which would also mean no payment has been received. Step 318 then proceeds to step 322, in which the gateway remains closed and the consumer is prevented from exiting the merchant facility 20. The negative result may be received by the server 100 if a predetermined time period has lapsed since the initiation of the second communication between the consumer wearable device 200 and the merchant communication device 40, and payment for the aggregated cost has not been made during this predetermined time period. The merchant communication device 40 or alert device may indicate a red light and/or sound a warning audio signal in step 322 to alert working staff in the merchant facility 20.

Therefore, the method 300 enables the consumer to track his/her usage of resources 30 at the merchant facility 20 with the consumer wearable device 200. The consumer wearable device 200 also calculates the aggregated cost for the resources 30 used by the consumer, such that the consumer only pays the merchant based on the actual usage of the resources 30. Notably, consumers pay different aggregated costs to the merchant depending on their usage of the resources 30. This model of charging consumers by the merchant facility 20 is advantageously fairer and more cost-effective to consumers and specific to each consumer's usage of the resources 30. As consumers do not pay a fixed fee upon entry into the merchant facility 20, they are less inclined to spend extra time resting/idling in the merchant facility 20 without using the resources 30. Moreover, some merchant facilities 20 may charge a nominal rate for such rest/idle time, deterring consumers from wasting time at the merchant facility 20. Consumers can more effectively spend their time actively using the resources 30 in the merchant facility 20, collectively resulting in less time spent in the merchant facility 20 for each consumer. The consumer turnaround time for the merchant facility 20 is thus shorter, allowing more consumers to patronize the merchant facility 20 and potentially resulting in higher income for the merchant.

In some embodiments, the merchant communication device 40 and server 100 records the date and time when a consumer enters and exits the merchant facility 20, particularly during the first and second communications, respectively, between the consumer wearable device 200 and the merchant communication device 40. This enables the merchant to obtain data on the duration of the consumer's session at the merchant facility 20. Collectively, the merchant may perform data analysis on the data to determine parameters, such as average duration of each consumer's session. The data analysis may assist the merchant in improving their business model for operating the merchant facility 20. The merchant may also perform data analysis on the resource usage data collectively provided by the consumer wearable devices 200. The data analysis may assist the merchant in determining which resources 30 are more popular and whether to implement changes to the resources 30, such as addition of new resources 30.

After using the resources 30, a consumer may attempt to exit the merchant facility 20 without paying the aggregated cost, particularly if the merchant facility 20 does not have a physical gantry to prevent this. Based on the consumer identification details received by the merchant in step 302, the merchant will be able to locate the fraudulent consumer and/or file a police report. Furthermore, in some embodiments and as insurance for the merchant, the merchant communication device 40 may additionally collect details of the digital wallet 204 or of a payment instrument of the consumer during step 302.

In one embodiment, the consumer taps his/her consumer wearable device 200 on the merchant communication device 40 when he/she enters and exits the merchant facility 20. However, the consumer did not pay the aggregated cost for using the resources 30 and exits the merchant facility anyway. The merchant may subsequently charge an amount based on the session duration to the digital wallet 204 or payment instrument. This amount may be punitive and higher than the aggregated cost. In another embodiment, the consumer does not tap the consumer wearable device 200 on the merchant communication device 40 when he/she exits the merchant facility 20 and also did not pay the aggregated cost. The merchant may subsequently charge an amount after a predefined time period has lapsed, such as 24 hours after the consumer has entered the merchant facility 20. Similarly, this amount may be punitive and higher than the aggregated cost. In yet another embodiment, the merchant charges a deposit amount to the digital wallet 204 or payment instrument when the consumer enters the merchant facility 20 and refunds any balance when the consumer exits the merchant facility 20.

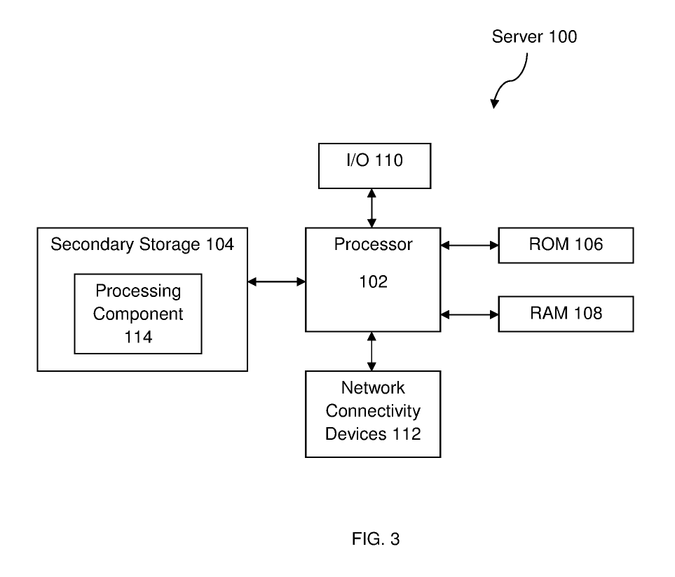

The following is a description of the technical architecture of the server 100 with reference to FIG. 3. It will be appreciated and readily understood by the skilled person that the consumer wearable device 200 and mobile device 202 may employ a similar technical architecture as for the server 100. It will also be appreciated and readily understood by the skilled person that the following description of the technical architecture of the server 100 may apply similarly or analogously to the technical architecture of the consumer wearable device 200 and mobile device 202.

The technical architecture of the server 100 includes a processor 102 (also referred to as a central processor unit or CPU) that is in communication with memory devices including secondary storage 104 (such as disk drives or memory cards), read only memory (ROM) 106, and random access memory (RAM) 108. The processor 102 may be implemented as one or more CPU chips. Various modules or components for performing various operations or steps of the method 300 are configured as part of the processor 102 and such operations or steps are performed in response to non-transitory instructions operative or executed by the processor 102.

The technical architecture further includes input/output (I/O) devices 110, and network connectivity devices 112. The secondary storage 104 typically includes a memory card or other storage device and is used for non-volatile storage of data and as an over-flow data storage device if RAM 108 is not large enough to hold all working data. Secondary storage 104 may be used to store programs which are loaded into RAM 108 when such programs are selected for execution.

The secondary storage 104 has a processing component 114, including non-transitory instructions operative by the processor 102 to perform various operations or steps of the method 300 according to various embodiments of the present disclosure. The ROM 106 is used to store instructions and perhaps data which are read during program execution. The secondary storage 104, the ROM 106, and/or the RAM 108 may be referred to in some contexts as computer-readable storage media and/or non-transitory computer-readable media. Non-transitory computer-readable media include all computer-readable media, with the sole exception being a transitory propagating signal per se.

The I/O devices 110 may include printers, video monitors, liquid crystal displays (LCDs), plasma displays, touch screen displays, keyboards, keypads, switches, dials, mice, track balls, voice recognizers, card readers, paper tape readers, and/or other known input devices.

The network connectivity devices 112 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other known network devices. These network connectivity devices 112 may enable the processor 102 to communicate with the Internet or one or more intranets. With such a network connection, it is contemplated that the processor 102 might receive information from the network, or might output information to the network in the course of performing the operations, or steps of the method 300. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors.

The technical architecture of the server 100 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third party provider.

It is understood that by programming and/or loading executable instructions onto the technical architecture of the server 100, at least one of the CPU 102, the ROM 106, and the RAM 108 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by known design rules.

In the foregoing detailed description, embodiments of the present disclosure in relation to an electronic system and method for managing usage of resources in a merchant facility are described with reference to the provided figures. The description of the various embodiments herein is not intended to call out or be limited only to specific or particular representations of the present disclosure, but merely to illustrate non-limiting examples of the present disclosure. For example, it will be appreciated that the aforementioned description may be extended to merchant facilities beyond gyms and fitness centres, such as but not limited to swimming complexes, or recreational centres, gaming centres, and amusement parks.

The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electronic system for managing usage of resources in a merchant facility, the system comprising a server and a merchant communication device, the server configured to:
receive, via the merchant communication device, identification details of a consumer from a wearable device of the consumer during a first communication;
communicate, via the merchant communication device, merchant data to the consumer wearable device upon receipt of the consumer identification details, the merchant data comprising rate details of the resources;
receive, via the merchant communication device, resource usage data provided by the consumer wearable device during a second communication, the resource usage data comprising an aggregated cost for the resources used by the consumer; and
receive a payment confirmation message upon transfer of the aggregated cost from a payment instrument of the consumer to a merchant financial account;
wherein usage of the resources is tracked by the consumer wearable device, and the aggregated cost is determined by the consumer wearable device based on the tracked usage and rate details of the resources.

2. The system according to claim 1, wherein usage of the resources is determined based on at least one of count, duration, and distance.

3. The system according to claim 1, wherein usage of the resources is tracked by the consumer wearable device based on anatomical movements of the consumer at each resource.

4. The system according to claim 1, wherein usage of the resources is tracked by the consumer wearable device based on proximity of the consumer wearable device to each resource.

5. The system according to claim 4, wherein proximity of the consumer wearable device to each resource is determined based on communication between the consumer wearable device and sensors located at the resources.

6. The system according to claim 1, wherein the aggregated cost is transferred from the payment instrument to the merchant financial account as a result of a payment transaction initiated by the consumer.

7. The system according to claim 1, further comprising a gateway communicatively linked to the server for the consumer to enter and exit the merchant facility, wherein the gateway is configured to prevent the consumer from exiting the merchant facility before the aggregated cost is transferred to the merchant financial account.

8. A computerized method implemented on a server for managing usage of resources in a merchant facility, the method comprising:
receiving, from a merchant communication device of the merchant facility, identification details of a consumer from a wearable device of the consumer during a first communication;
communicating merchant data from the merchant communication device to the consumer wearable device upon receipt of the consumer identification details, the merchant data comprising rate details of the resources;
receiving, via the merchant communication device, resource usage data provided by the consumer wearable device during a second communication, the resource usage data comprising an aggregated cost for the resources used by the consumer; and
receiving a payment confirmation message upon transfer of the aggregated cost from a payment instrument of the consumer to a merchant financial account;
wherein usage of the resources is tracked by the consumer wearable device, and the aggregated cost is determined by the consumer wearable device based on the tracked usage and rate details of the resources.

9. The method according to claim 8, wherein usage of the resources is determined based on at least one of count, duration, and distance.

10. The method according to claim 8, wherein usage of the resources is tracked by the consumer wearable device based on anatomical movements of the consumer at each resource.

11. The method according to claim 8, wherein usage of the resources is tracked by the consumer wearable device based on proximity of the consumer wearable device to each resource.

12. The method according to claim 11, wherein proximity of the consumer wearable device to each resource is determined based on communication between the consumer wearable device and sensors located at the resources.

13. The method according to claim 8, wherein the aggregated cost is transferred from the payment instrument to the merchant financial account as a result of a payment transaction initiated by the consumer.

14. The method according to claim 8, further comprising preventing, by a gateway communicatively linked to the server for the consumer to enter and exit the merchant facility, the consumer from exiting the merchant facility before the aggregated cost is transferred to the merchant financial account.

15. (canceled)

16. A device wearable by a consumer for managing usage of resources in a merchant facility, the consumer wearable device linked to a digital wallet of the consumer and configured to:
communicate, to a merchant communication device of the merchant facility, identification details of the consumer during a first communication;
receive merchant data from the merchant communication device upon communication of the consumer identification details, the merchant data comprising rate details of the resources;
communicate, via the merchant communication device, resource usage data during a second communication, the resource usage data comprising an aggregated cost for the resources used by the consumer; and
transfer the aggregated cost from a payment instrument of the consumer to a merchant financial account, the payment instrument linked to the digital wallet;
wherein usage of the resources is tracked by the consumer wearable device, and the aggregated cost is determined by the consumer wearable device based on the tracked usage and rate details of the resources.

17. The device according to claim 16, wherein the device is further configured to determine usage of the resources based on at least one of count, duration, and distance.

18. The device according to claim 16, wherein the device is further configured to track usage of the resources based on anatomical movements of the consumer at each resource.

19. The device according to claim 16, wherein the device is further configured to track usage of the resources based on proximity of the consumer wearable device to each resource.

20. The device according to claim 16, wherein the aggregated cost is transferred from the payment instrument to the merchant financial account as a result of a payment transaction initiated by the consumer with the digital wallet.
